(19) United States
(12) Patent Application Publication
(10) Pub. No.: US 2026/0163381 A1
(43) Pub. Date: Jun. 11, 2026

(54) PORTABLE GASOLINE-POWERED BATTERY CHARGER

(71) Applicant: Sarah Noell, Wildwood, FL (US)

(72) Inventor: Sarah Noell, Wildwood, FL (US)

(21) Appl. No.: 18/971,319

(22) Filed: Dec. 6, 2024

(51) Int. Cl. H02J 7/14; H02J 7/00

(52) U.S. Cl. CPC H02J 7/1415; H02J 7/1476; H02J 7/40; H02J 7/751; H02J 7/82

(57) ABSTRACT

A portable gasoline-powered battery charger is disclosed, including a gasoline powered engine and an alternator coupled to the gasoline powered engine via a bracket. The alternator is in electrical communication with a charging cable to transfer electrical current to a battery. A timer is in operable communication with a shut off switch, the timer to automatically shut off the gasoline powered engine once a time interval has elapsed.

### TECHNICAL FIELD

The embodiments disclosed herein generally relate to portable battery chargers.

### BACKGROUND

Rechargeable batteries are cable of being charged, discharged into a load, and recharged repeatedly and are produced in many shapes and sizes and are employed in a variety of devices and machinery which require electrical power. In some instances, rechargeable batteries receive power from an electric power source. While useful, this requires access to electrical power which can be difficult or impossible in some scenarios such as in off-grid environments, or when the power grid is inoperable. Portable electric chargers are well known. However, with current technology their power storage capabilities are limited. In such, they are either incapable of charging some batteries, or may only be used for a limited time before they themselves must be recharged.

Rather than receiving power from an electrical power source, it is common for gas-powered electric generators to be used. These devices utilize a fuel-based power source to run an engine, which can then convert mechanical energy into electric energy. Vehicles perform this using an alternator which recharges the vehicle's battery by converting mechanical energy produced by the vehicle's engine into electric energy.

While battery chargers are widely available in various forms, many are too large to easily transport. Portable battery chargers which are currently available are incapable of providing continuous charging over extended periods of time

### SUMMARY OF THE INVENTION

This summary is provided to introduce a variety of concepts in a simplified form that is further disclosed in the detailed description of the embodiments. This summary is not intended for determining the scope of the claimed subject matter.

A portable gasoline-powered battery charger is disclosed, including a gasoline powered engine and an alternator coupled to the gasoline powered engine via a bracket. The alternator is in electrical communication with a charging cable to transfer electrical current to a battery. A timer is in operable communication with a shut off switch, the timer to automatically shut off the gasoline powered engine once a time interval has elapsed.

The portable gasoline-powered battery charger allows the apparatus to be easily transported to an area where grid power or other power supplies are not feasible to connect to. This may be advantageous for charging a battery during a power outage, in an area where grid power is inaccessible, or at nighttime when connection to a solar cell is not feasible, etc.

Use of a gas-powered engine in connection with an alternator enables long-term and repeated charging of the battery which may not be feasible with power storage systems (i.e., electrical power banks) which would need to eventually be charged themselves.

In one aspect, the alternator is a 12-volt alternator to enable charging of one or more 12-volt batteries.

In one aspect, a handle is mounted to the bracket, wherein the handle facilitates transportation of the portable battery charger.

In one aspect, the timer is in operable communication with a controller to enable the input of one or more operational settings.

In one aspect, the alternator includes at least one pulley and at least one belt to transfer engine power to the alternator.

In one aspect, the bracket is coupled to a cover to at least partially enclose the alternator.

In one aspect, the cover includes at least one vent to enable the flow of air through the cover to cool the alternator.

In one aspect, the cover includes a top, a first side, a second side, and a front, and wherein the cover has an open bottom.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the portable gasoline-powered battery charger, according to some embodiments;

FIG. 2 illustrates a perspective view of the portable gasoline-powered battery charger in electrical connection with a battery, according to some embodiments; and

FIG. 3 illustrates a block diagram of the controller and timer of the portable gasoline-powered battery charger, according to some embodiments.

### DETAILED DESCRIPTION OF THE INVENTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a portable gasoline powered battery charger which includes a gasoline powered engine and an alternator coupled to one another using a bracket, pulley system and a belt. The portable gasoline powered battery charger may be used to charge 12-volt batteries (according to one example) used to power battery operated device. A time may be used to automatically shut down the portable gasoline powered battery charger after a period of operation, such that the operator does not need to shut down the engine manually.

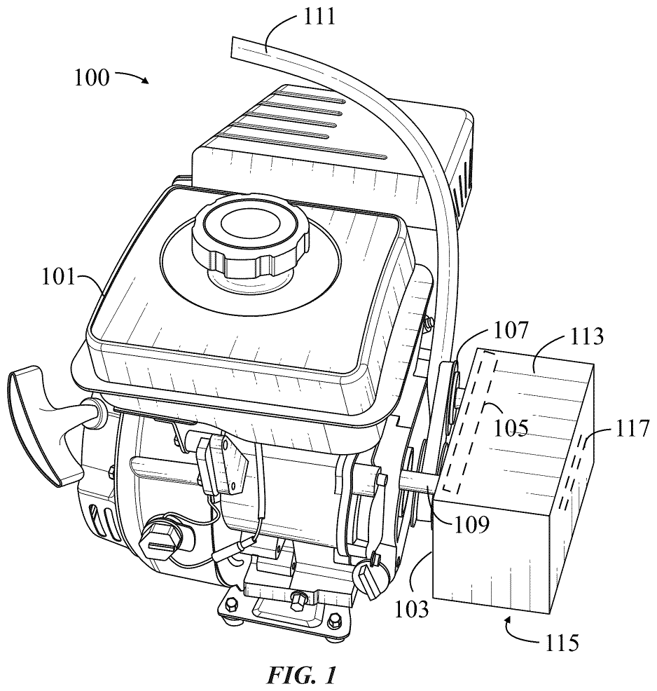

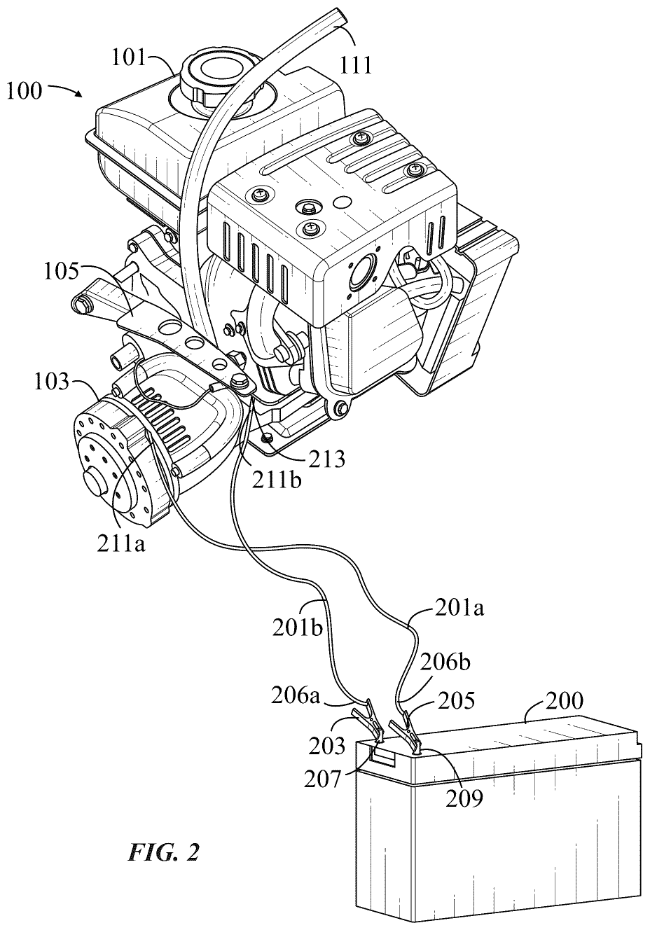

FIG. 1 and FIG. 2 illustrate the portable gasoline-powered battery charger 100 which includes an engine 101 which is gasoline-powered and capable of delivery power to an alternator 103. The alternator 103 is connected, via a bracket 105 to the engine 101 which provides a means of mounting the alternator 103. The engine drives a pulley system 107 connected to a drive shaft 109 in order to turn the alternator 103 and convert mechanical energy produced by the engine 101 into electrical energy used to charge the battery. A handle 111 is attached to the engine 101, or the bracket 103 to enable efficient and easy carrying of the portable gasoline-powered battery charger 100. A cover 113 is positioned over the alternator 103 as is shown in FIG. 1. The cover 113 protects the alternator while providing a heat sink to transfer heat away from the alternator 103 during its operation. The cover 113 may be constructed having an open bottom 115 and/or one or more vents 117 to promote airflow into the interior cavity within the cover 113.

In some embodiments, the cover 113 is mounted to the bracket 105 to enable the selective removal of the cover 113. This may allow the user to service components of the portable gasoline-powered battery charger 100 such as the pulley system 107.

In some embodiments, the cover 113 may be pivotally mounted via the bracket 105. In such, the user can pivot the cover to expose the alternator 103, without disconnecting the cover 113 from the bracket 105.

In some embodiments, the pulley system 107 includes the drive shaft 109 which is connected to at least one pulley wheel and belt(s). In such, the pulley wheel rotates and connects to the alternator 103 via the belts which transmits rotational movement to the alternator 103.

FIG. 2 illustrates the portable gasoline-powered battery charger 100 which is in electrical communication to a battery 200 via cables 201a, 201b. It is noted that the cover 113 (see FIG. 1) has been removed to illustrate the alternator 103 and other components contained within the cover 113. The cables 201a, 201b include a positive lead 203 and a negative lead 205 each positioned on first ends 206a, 206b which connect to the positive terminal 207 and negative terminal 209 of the battery 200. Second ends 211a, 211b are connected to the alternator 103 and grounding location 213 in order to effectively deliver electrical power generated by the alternator 103 to the battery 200.

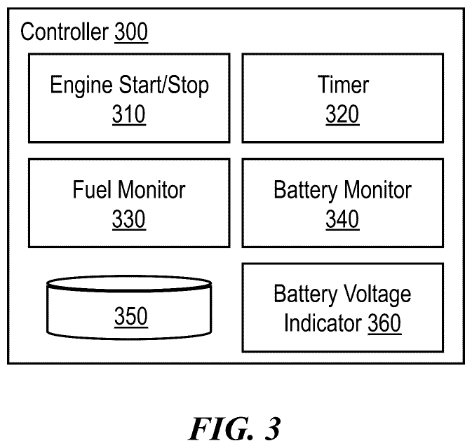

FIG. 3 illustrates a block diagram of the controller 300 which is used to monitor and operate the various functionalities of the portable gasoline-powered battery charger 100. The controller 300 includes an engine start/stop 310, timer 320, fuel monitor 330, battery monitor 340, memory 350, and battery voltage indicator 360. The engine start/stop 310 is operable to start and/or stop the engine at pre-programmed time intervals. A timer 320 is capable of timing the operation of the engine to stop the engine once the time period has elapsed. Memory 350 stores operational settings which may include run time of the engine for specific batteries, etc.

In some embodiments, a battery monitor 340 is operable to monitor the charge of the battery, such that the user is notified (such as via an indicator light or lights) when the battery is partially or fully charged.

In some embodiments, the battery monitor 340 may be in operable communication with a battery voltage indicator 360 which displays the battery voltage and allows the system to determine the voltage reserved by the battery.

In some embodiments, a fuel monitor 330 may be used to monitor the amount of fuel in the fuel tank of the engine. This may provide a notification to the user (such as illuminating an indicator light) if the fuel level is below a certain threshold. In such, the user is notified when they should fill the fuel tank.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A portable battery charger, comprising:
a gasoline powered engine;
an alternator coupled to the gasoline powered engine via a bracket, the alternator in electrical communication with a charging cable to transfer electrical current to a battery; and
a timer in operable communication with a shut off switch, the timer to automatically shut off the gasoline powered engine once a time interval has elapsed.

2. The portable battery charger of claim 1, wherein the alternator is a 12-volt alternator to enable charging of one or more 12-volt batteries.

3. The portable battery charger of claim 1, further comprising a handle mounted to the bracket, wherein the handle facilitates transportation of the portable battery charger.

4. The portable battery charger of claim 1, wherein the timer is in operable communication with a controller to enable the input of one or more operational settings.

5. The portable battery charger of claim 1, wherein the alternator includes at least one pulley and at least one belt to transfer engine power to the alternator.

6. The portable battery charger of claim 1, wherein the bracket is coupled to a cover to at least partially enclose the alternator.

7. The portable battery charger of claim 6, wherein the cover includes at least one vent to enable the flow of air through the cover to cool the alternator.

8. The portable battery charger of claim 7, wherein the cover includes a top, a first side, a second side, and a front, and wherein the cover has an open bottom.

9. A gasoline-powered portable battery charger, comprising:
a gasoline powered engine;
an alternator coupled to the gasoline powered engine via a bracket, the alternator in electrical communication with a charging cable having a positive terminal and a negative terminal to connect to a battery and to transfer electrical current to the battery;
a controller electrically coupled to a shut-off switch; and
a timer in operable communication with the controller, the timer to automatically shut off the gasoline powered engine once a time interval has elapsed.

10. The portable battery charger of claim 9, wherein the alternator is a 12-volt alternator to enable charging of one or more 12-volt batteries.

11. The portable battery charger of claim 9, further comprising a handle mounted to the bracket, wherein the handle facilitates transportation of the portable battery charger.

12. The portable battery charger of claim 9, wherein the controller enable the input of one or more operational settings.

13. The portable battery charger of claim 12, wherein the controller includes a battery monitor to enable the monitoring of the charge of the battery.

14. The portable battery charger of claim 9, wherein the alternator includes at least one pulley and at least one belt to transfer engine power to the alternator.

15. The portable battery charger of claim 9, wherein the bracket is coupled to a cover to at least partially enclose the alternator.

16. The portable battery charger of claim 14, wherein the cover includes at least one vent to enable the flow of air through the cover to cool the alternator.

17. The portable battery charger of claim 15, wherein the cover includes a top, a first side, a second side, and a front, and wherein the cover has an open bottom.

18. A gasoline-powered portable battery charger, comprising:
a gasoline powered engine powering an alternator coupled to the gasoline powered engine via a bracket, the alternator in electrical communication with one or more charging cables to each transfer electrical current to one or more batteries;
a positive terminal and a negative terminal positioned at an end of the one or more charging cables, the positive terminal and the negative terminal being capable of releasably connecting to the battery;
a controller electrically coupled to a shut-off switch;
a timer in operable communication with the controller, the timer to automatically shut off the gasoline powered engine once a time interval has elapsed; and
a handle attached to the bracket, the handle to facilitate carrying the gasoline-powered portable battery charger.

19. The portable battery charger of claim 18, wherein the bracket is coupled to a cover to at least partially enclose the alternator.

20. The portable battery charger of claim 19, wherein the cover includes at least one vent to enable the flow of air through the cover to cool the alternator.
